(19) United States
(12) Patent Application Publication
(10) Pub. No.: US 2011/0141537 A1
(43) Pub. Date: Jun. 16, 2011

(54) LIGHT SCANNING APPARATUS

(76) Inventor: Tomoya IWASAKI, Ueda-shi (JP)

(21) Appl. No.: 12/959,001

(22) Filed: Dec. 2, 2010

(30) Foreign Application Priority Data
Dec. 15, 2009 (JP) 2009-283661

(51) Int. Cl. G02B 26/10

(52) U.S. Cl. 359/223.1

(57) ABSTRACT

In the light scanning apparatus, flatness of a mirror section can be improved. The light scanning apparatus comprises: a substrate having an opening part; a mirror section being located in the opening part of the substrate, the mirror section having side parts, which are held by a beam; and a vibration source being provided on the substrate, the vibration source bending the substrate so as to swing the mirror section on the beam which acts as a pivot shaft. The mirror section swung by the vibration source reflects an irradiated light for scanning operation. The mirror section is constituted by a metal base plate and a mirror surface member, which is bonded to the metal base plate by an elastic adhesive.

### CROSS-REFERENCE TO RELATED APPLICATION

This application is based upon and claims the benefit of priority of the prior Japanese Patent Application No. P2009-283661, filed on Dec. 15 2009, and the entire contents of which are incorporated herein by reference.

### FIELD

The present invention relates to a light scanning apparatus, in which scanning operation is performed by reflecting a light beam irradiated from a light source with a swung mirror section.

### BACKGROUND

A light scanning apparatus, which scans with a light beam, e.g., laser beam irradiated from a light source, is used in optical equipments, e.g., laser printer, imaging unit of digital copier, image projector, barcode reader, area sensor.

A conventional light scanning apparatus will be explained. A rectangular substrate, which is composed of, for example, stainless steel or silicon, is held, by a holding member, like a cantilever, and an opening part is formed in a free end part of the substrate. A mirror section is provided in the opening part, and both sides of the mirror section are connected to the substrate by a beam or beams. A surface of the mirror section is polished like a mirror, reflection coating is formed on the surface of the mirror section, or a mirror is adhered thereon.

A vibration source, which is composed of a film of a piezoelectric substance, a magnetostrictive substance or a permanent magnet, is provided on the substrate. For example, in case of using the piezoelectric substance, the vibration source is extended by applying positive voltage and shrunk by applying negative voltage, so that the substrate is bent. By bending the substrate upward and downward, twisting vibration is generated in the beams, so that the mirror section is swung.

In Japanese Laid-open Patent Publication No. P2006-293116A, for example, a metal substrate composed of stainless steel (SUS) is used. A metal plate corresponding to a mirror section is polished and fully flattened, and then a silicon mirror is bonded to the substrate. The silicon mirror is constituted by a base plate, which is composed of silicon or glass, and a high reflectance film, which is formed on the base plate.

In Japanese Laid-open Patent Publication No. P2009-175368A, a mirror is bonded to a substrate by an adhesive, e.g., epoxy resin adhesive, UV curable resin adhesive.

In the above described conventional light scanning apparatus, the mirror section which is formed by polishing the metal plate has insufficient flatness and surface roughness. Further, by bonding the silicon mirror to the base plate with an instant adhesive (e.g., epoxy resin adhesive, cyanoacrylate resin adhesive), the silicon mirror will be deformed when the adhesive cures. Therefore, the flatness of the silicon mirror will be lowered. For example, the flatness of the silicon mirror is a peak-valley value of 500 nm or more. In this case, a width of a scanning line, which is reflected by the mirror section, of a laser color printer will be varied.

### SUMMARY

Accordingly, it is an object in one aspect of the invention to provide a light scanning apparatus in which flatness of a mirror section can be improved.

To achieve the object, the light scanning apparatus of the present invention comprises:
a substrate having an opening part;
a mirror section being located in the opening part of the substrate, the mirror section having side parts, which are held by a beam; and
a vibration source being provided on the substrate, the vibration source bending the substrate so as to swing the mirror section on the beam which acts as a pivot shaft,

the mirror section swung by the vibration source reflects an irradiated light for scanning operation, and

the mirror section is constituted by a metal base plate and a mirror surface member, which is bonded to the metal base plate by an elastic adhesive.

In the light scanning apparatus, hardness of the elastic adhesive is Shore-A hardness of 90 or less.

In the light scanning apparatus, the elastic adhesive is one of silicon resin adhesive, deformed silicon polymer resin adhesive, urethane resin adhesive and synthetic rubber adhesive.

In the light scanning apparatus, flatness of the mirror section is a peak-valley value of 500 nm or less, preferably 200 nm or less, more preferably 100 nm or less.

In the light scanning apparatus of the present invention, the flatness of the mirror section is a peak-valley value of 500 nm or less, preferably 200 nm or less, more preferably 100 nm or less, so the flatness of the mirror section can be highly improved.

The metal base plate, on which the mirror surface member is bonded, need not be polished, so a production process of the light scanning apparatus can be simplified.

A width of a scanning line of, for example, a laser color printer can be highly precisely maintained, so that high quality of images can be maintained.

### BRIEF DESCRIPTION OF THE DRAWINGS

Embodiments of the present invention will now be described by way of examples and with reference to the accompanying drawings, in which:

FIG. 1A is a plan view of an embodiment of the light scanning apparatus of the present invention;

FIG. 1B is a sectional view of the light scanning apparatus taken along a line A-A of FIG. 1A;

FIG. 2 is an enlarged view of a mirror section;

FIG. 3 is a data table showing flatness of several types of adhesives;

FIG. 4 is a graph showing flatness of the mirror section of Example 1, in which a deformed silicon polymer resin adhesive is used;

FIG. 5 is a graph showing flatness of the mirror section of Example 2, in which a urethane resin adhesive is used;

FIG. 6 is a graph showing flatness of the mirror section of Comparative Example 1, in which a cyanoacrylate resin adhesive is used;

FIG. 7 is a graph showing flatness of the mirror section of Comparative Example 2, in which an epoxy resin adhesive is used; and

FIG. 8 is a graph showing flatness of the mirror section of Comparative Example 3, in which another epoxy resin adhesive is used.

### DETAILED DESCRIPTION OF THE EMBODIMENTS

Preferred embodiments of the present invention will now be described in detail with reference to the accompanying drawings. In the following embodiments, a scanner for a laser beam printer will be explained as the light scanning apparatus.

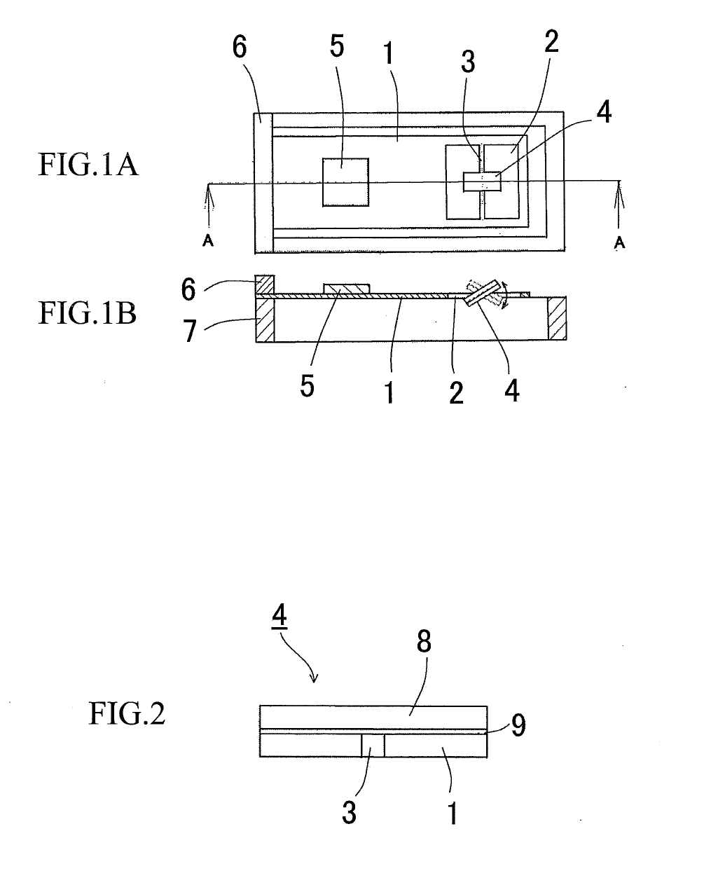

A first embodiment of the light scanning apparatus will be explained with reference to FIGS. 1A and 1B.

A substrate 1 is a rectangular metal plate composed of, for example, stainless steel (SU304). An opening part (through-hole) 2 is formed in a part closer to a longitudinal end of the substrate 1 than a longitudinal center thereof. A beam 3 is spanned in the central part of the opening part 2, and a mirror section 4 is integrally supported by a beam 3. The mirror section 4 is axial-symmetrically formed with respect to the beam 3. A vibration source 5 is provided on the substrate 1 and on the side opposite to the mirror section 4. The vibration source 5 is a piezoelectric element composed of lead zirconate titanate (PZT). One end of the substrate 1, on the vibration source 5 side, is held by a substrate holding member 6 and a base section 7.

Vibration of the mirror section 4 will be explained. By applying positive (+) voltage to a surface electrode of the piezoelectric element, a piezoelectric layer is extended, so that the substrate 1 is bent upward. On the other hand, by applying negative (−) voltage to the surface electrode of the piezoelectric element, the piezoelectric layer is shrunk, so that the substrate 1 is bent downward. When the substrate 1 is bent, stationary waves generated in the substrate 1, which is supported by the beam 3, twist the beam 3 and generate rotational moment in the mirror section 4, which is in a horizontal state, so that twisting vibration is generated.

By applying alternate voltage to the vibration source 5 to repeatedly bend parts of the substrate 1, which are on the both sides of the beam 3, in opposing directions, the mirror section 4 is vibrated with prescribed amplitude. By irradiating a light, e.g., laser beam, toward the mirror section 4 in a state where the mirror section 4 is swung on the beam 3, which acts as a twist axis, with the prescribed amplitude, the reflected laser beam can be scanned.

Besides the piezoelectric element, a film of a piezoelectric substance, a magnetostrictive substance or a permanent magnet may be directly formed on the substrate 1 as the vibration source 5. The film may be formed by known film forming methods, e.g., aerosol deposition (AD) method, vacuum evaporation method, sputtering method, chemical vapor deposition (CVD) method, sol-gel method. By directly forming the film of a piezoelectric substance, a magnetostrictive substance or a permanent magnet on the substrate 1, a light scanning apparatus, which is driven at a low voltage and whose electric power consumption is low, can be produced.

In case of employing a magnetostrictive substance or a permanent magnet as the vibration source 5, by applying alternate magnetic fields to a coil located in the vicinity of the film of the magnetostrictive substance or permanent magnet formed on the substrate 1, an alternate current passes through the coil, so that alternate magnetic fields are generated. Note that, in case of forming the film of the magnetostrictive substance or permanent magnet formed on the substrate 1, a nonmagnetic material is suitably selected as a material of the substrate 1 so as to efficiently bend the substrate 1.

Next, the structure of the mirror section 4 will be explained with reference to FIG. 2.

In the mirror section 4, a silicon mirror (mirror surface member) 8, in which a mirror surface is formed on a silicon substrate, is bonded onto the substrate 1 by an elastic adhesive 9. In the silicon mirror 8, a thin film (e.g., chrome thin film, metal thin film) is formed, by a known film forming method, e.g., sputtering method, on a silicon (Si) substrate whose surface has been polished like a mirror. Note that, the material of the mirror surface member 8 is not limited to silicon. A type of the elastic adhesive 9 is selected according to the materials of the metal base plate 10 and the mirror surface member.

The elastic adhesive is one selected from silicon resin adhesive, deformed silicon polymer resin adhesive (e.g., Super XG No. 777/Clear Type produced by Cemedine Co., Ltd), urethane resin adhesive (e.g., Bond Ultra/Utility/SU produced by Konishi Co., Ltd.) and synthetic rubber adhesive. By employing the elastic adhesive 9, flatness of the silicon mirror 8 can be improved and a step of polishing the metal base plate 10, on which the silicon mirror 8 is bonded, can be omitted, so that a production process of the light scanning apparatus can be simplified.

Next, the elastic adhesive will be explained. There are two definitions of elastic adhesive, in the business field of producing adhesives, as follows:

(1) Functional adhesives, each of which is specialized to elastic function and cures with chemical reaction and whose cured surface is extended like a rubber band by applying an external force and returned to an initial state by releasing the external force, are called elastic adhesives.

(2) Hardness of elastic adhesives are indicated by a durometer type A as Shore-A hardness. The Shore-A hardness is measured by the steps of: pressing a standard press member called push needle or indenter into a surface of a substance to be measured; measuring an amount of deformation (i.e., depth); and quantifying the measured amount by a durometer (e.g., spring type rubber hardness meter). In case that the Shore-A hardness is low, the substance is soft. On the other hand, in case that the Shore-A hardness is high, the substance is hard. A range of the Shore-A hardness of elastic adhesives is 20-90. For example, the Shore-A hardness of Super XG No. 777/Clear Type produced by Cemedine Co., Ltd is 82, so it is classified as an elastic adhesive. Note that, no elastic adhesives whose Shore-A hardness are more than 90 are not found at the present time.

Instant adhesives and thermosetting adhesives are not nonelastic adhesives clearly, so their hardness cannot be indicated as the Shore-A hardness for indicating hardness of elastic substances. Therefore, there are no data of their hardness indicated as the Shore-A hardness. If their hardness are indicated as the Shore-A hardness, the values must be more than 90. Usually, their hardness are indicated as Shore-D hardness.

To clearly explain the technology of the present invention without being questioned, the adhesives whose Shore-A hardness are 90 or less are defined as the elastic adhesives, as described in the above item (2), in the present embodiment.

Next, the silicon mirror 8 is suitably bonded to have flatness of a peak-valley value of 500 nm or less, preferably 200 nm or less, more preferably 100 nm or less.

Examples 1 and 2 of the present invention and comparative examples 1-3 will be explained. In each of the examples and the comparative examples, a size of the silicon mirror 8 was 4.6×1.2×0.28 mm, and a thickness of the substrate 1 was 0.15 mm.

### EXAMPLE 1

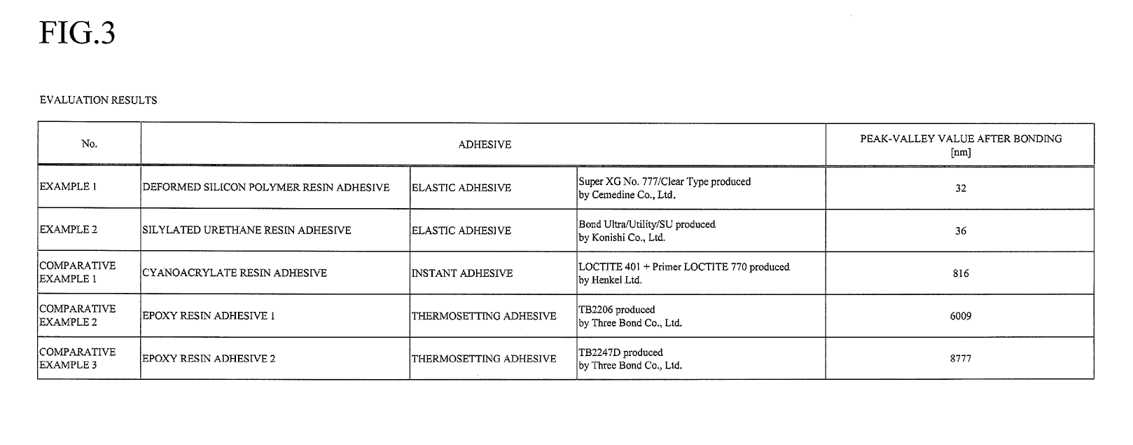

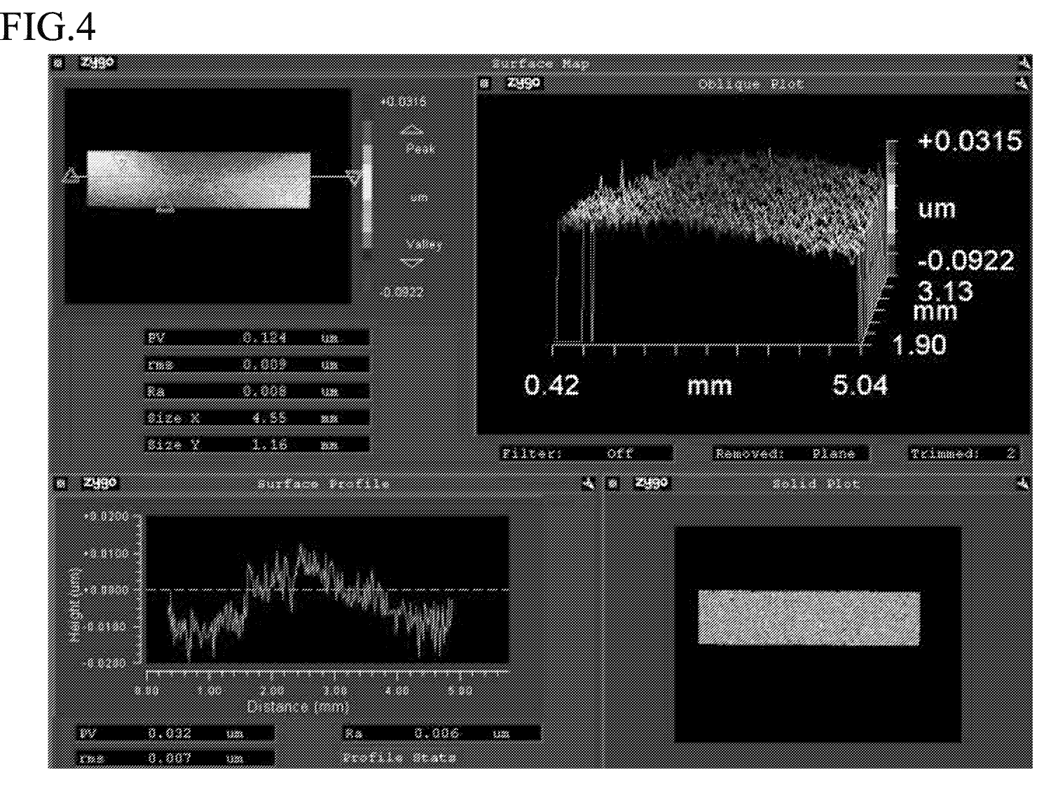

Super XG No. 777/Clear Type produced by Cemedine Co., Ltd, whose Shore-A hardness was 82, was applied on the metal base plate 10, as the elastic adhesive 9, and the silicon mirror 8 was bonded thereon. They were left for one hour at the room temperature, and then flatness was measured and evaluated by a noncontact profilometer New View 5000 produced by Zygo Corporation. An evaluation result of flatness of the silicon mirror 8 is shown in FIG. 3. The flatness was evaluated as a peak-valley (PV) value. The PV value was 32 nm (see FIG. 4).

### EXAMPLE 2

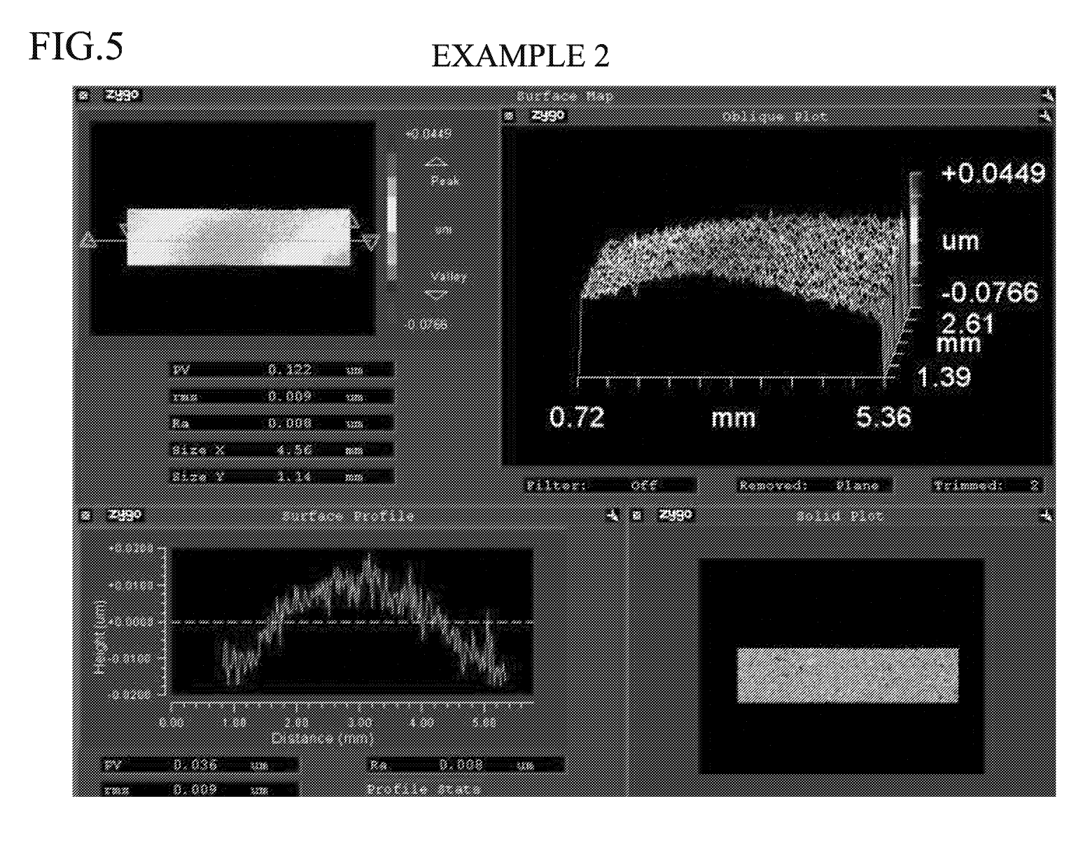

Bond Ultra/Utility/SU produced by Konishi Co., Ltd., whose Shore-A hardness was 40, was applied on the metal base plate 10, as the elastic adhesive 9, and the silicon mirror 8 was bonded thereon. They were left for one hour at the room temperature, and then flatness was measured and evaluated by the noncontact profilometer New View 5000 produced by Zygo Corporation. An evaluation result of flatness of the silicon mirror 8 is shown in FIG. 3. The flatness was evaluated as a peak-valley (PV) value. The PV value was 36 nm (see FIG. 5).

### COMPARATIVE EXAMPLE 1

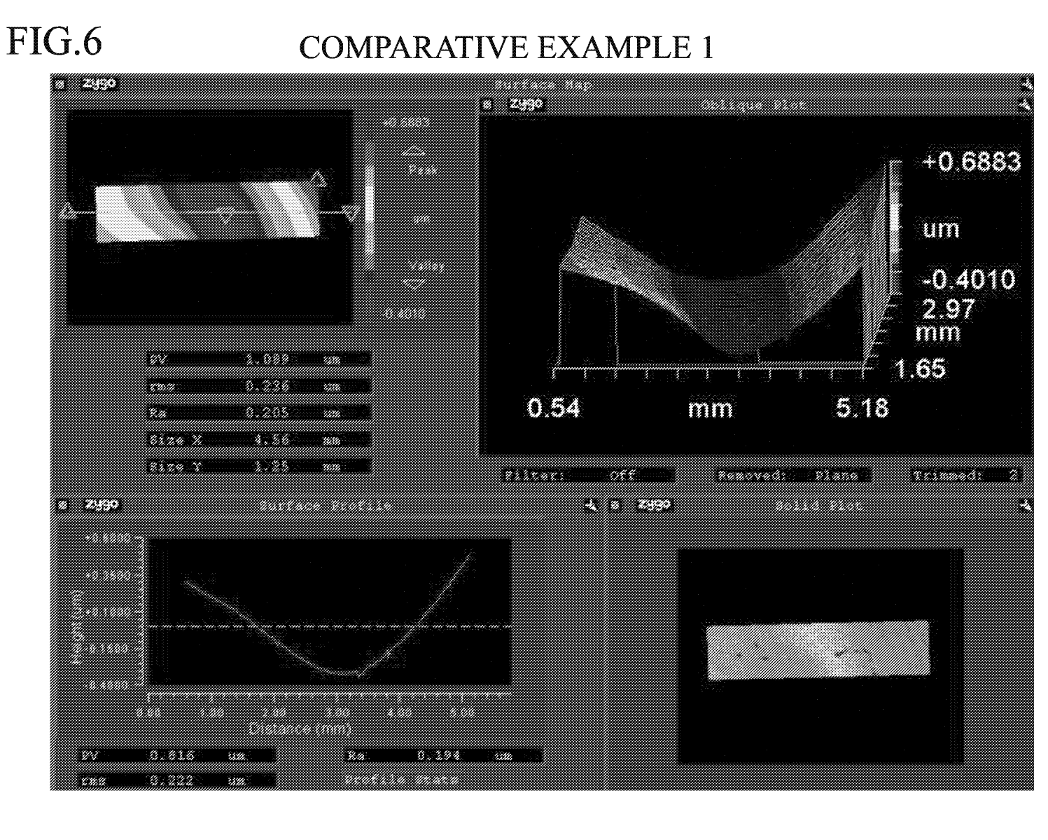

An instant adhesive (nonelastic adhesive) LOCTITE 401 produced by Henkel Ltd. was applied on the metal base plate 10, as an adhesive, and the silicon mirror 8 was bonded thereon. They were left for one hour at the room temperature, and then flatness was measured and evaluated by the noncontact profilometer New View 5000 produced by Zygo Corporation. An evaluation result of flatness of the silicon mirror 8 is shown in FIG. 3. The flatness was evaluated as a peak-valley (PV) value. The PV value was 816 nm (see FIG. 6). Note that, as described above, the instant adhesive is not an elastic adhesive, so its hardness cannot be indicated as the Shore-A hardness.

### COMPARATIVE EXAMPLE 2

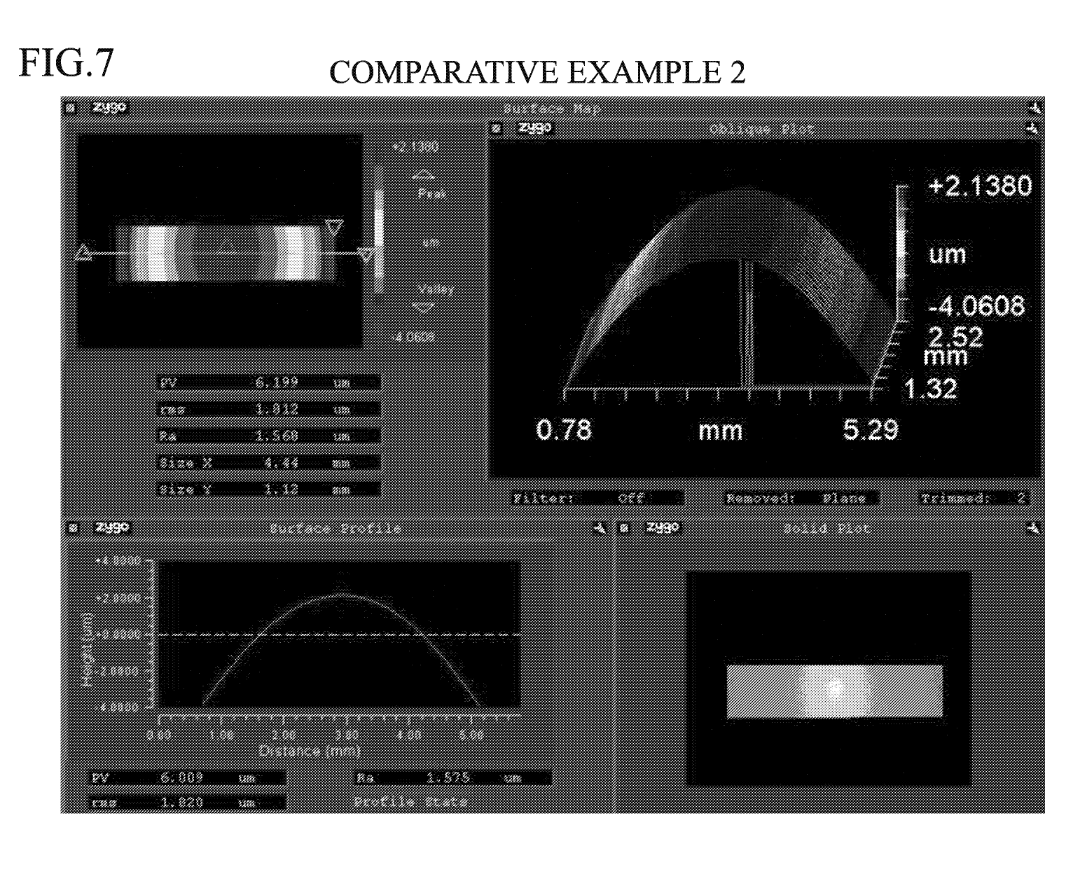

A thermosetting adhesive (nonelastic adhesive) TB2206 produced by Three Bond Co., Ltd. was applied on the metal base plate 10, as an adhesive, and the silicon mirror 8 was bonded thereon. They were heated for 30 minutes at temperature of 80° C. so as to make the adhesive cure, and then flatness was measured and evaluated by the noncontact profilometer New View 5000 produced by Zygo Corporation. An evaluation result of flatness of the silicon mirror 8 is shown in FIG. 3. The flatness was evaluated as a peak-valley (PV) value. The PV value was 6009 nm (see FIG. 7). Note that, as described above, the instant adhesive is not an elastic adhesive, so its hardness cannot be indicated as the Shore-A hardness.

### COMPARATIVE EXAMPLE 3

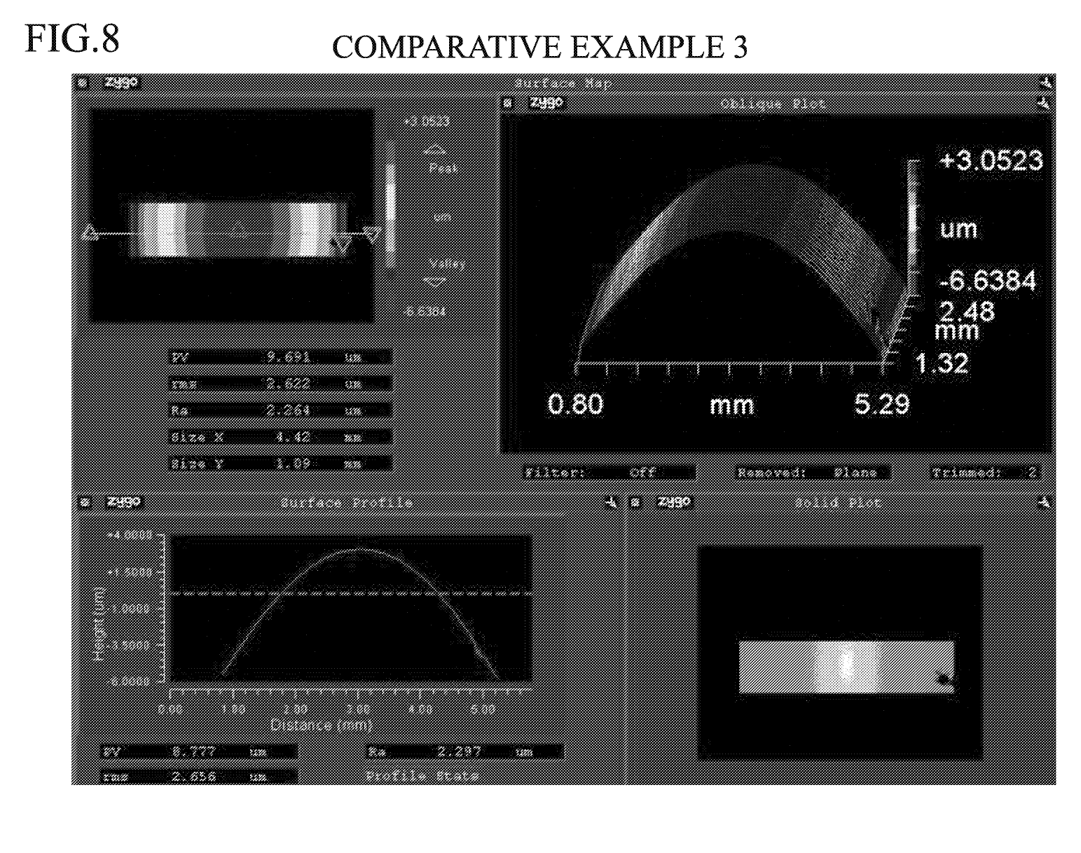

A thermosetting adhesive (nonelastic adhesive) TB22247D produced by Three Bond Co., Ltd. was applied on the metal base plate 10, as an adhesive, and the silicon mirror 8 was bonded thereon. They were heated for 30 minutes at temperature of 150° C. so as to make the adhesive cure, and then flatness was measured and evaluated by the noncontact profilometer New View 5000 produced by Zygo Corporation. An evaluation result of flatness of the silicon mirror 8 is shown in FIG. 3. The flatness was evaluated as a peak-valley (PV) value. The PV value was 8777 nm (see FIG. 8). Note that, as described above, the instant adhesive is not an elastic adhesive, so its hardness cannot be indicated as the Shore-A hardness.

As to the thickness of the substrate 1, in case of employing silicon (Si), stainless steel (e.g., SUS304) or grown carbon nanotubes as a material of the substrate 1, a preferable thickness of the substrate 1 is 10 μm or more in view of the flatness of the mirror in operation and a size of the mirror to be assembled in, for example, a projector device.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention has been described in detail, it should be understood that the various changes, substitutions, and alternations could be made hereto without departing from the spirit and scope of the invention.

What is claimed is:

1. A light scanning apparatus,
comprising:
a substrate having an opening part;
a mirror section being located in the opening part of the substrate, the mirror section having side parts, which are held by a beam; and
a vibration source being provided on the substrate, the vibration source bending the substrate so as to swing the mirror section on the beam which acts as a pivot shaft,
wherein the mirror section swung by the vibration source reflects an irradiated light for scanning operation, and
the mirror section is constituted by a metal base plate and a mirror surface member, which is bonded to the metal base plate by an elastic adhesive.

2. The light scanning apparatus according to claim 1,
wherein hardness of the elastic adhesive is Shore-A hardness of 90 or less.

3. The light scanning apparatus according to claim 1,
wherein the elastic adhesive is one of silicon resin adhesive, deformed silicon polymer resin adhesive, urethane resin adhesive and synthetic rubber adhesive.

4. The light scanning apparatus according to claim 1,
wherein flatness of the mirror section is a peak-valley value of 500 nm or less, preferably 200 nm or less, more preferably 100 nm or less.
